(19) United States
(12) Patent Application Publication
(10) Pub. No.: US 2020/0274758 A1
(43) Pub. Date: Aug. 27, 2020

(54) PROVISIONING HYBRID CLOUD RESOURCES IN AN OPERATING ENVIRONMENT

(71) Applicant: Hewlett Packard Enterprise Development LP, Houston, TX (US)

(72) Inventors: Sonu Sudhakaran, Bangalore Karnataka (IN); Divakar Padiyar Nandavar, Bangalore Karnataka (IN)

(21) Appl. No.: 16/387,498

(22) Filed: Apr. 17, 2019

(30) Foreign Application Priority Data
Feb. 25, 2019 (IN) 201941007351

(51) Int. Cl. H04L 12/24; H04L 29/08

(52) U.S. Cl. CPC H04L 41/0806; H04L 67/10

(57) ABSTRACT

Example implementations relate to provisioning hybrid cloud resources in an operating environment. A computing device may comprise a processing resource and a memory resource storing non-transitory machine-readable instructions to cause the processing resource to instantiate an operating environment according to a pre-determined operating environment configuration, provision hybrid cloud resources for the operating environment using the pre-determined operating environment configuration, and perform an operation relating to an application using the provisioned hybrid cloud resources provided by at least one cloud service provider included in a pre-determined application specification.

### BACKGROUND

Cloud service providers may provide computing resources for various uses. For example, computing resources may be utilized to develop applications. Computing resources from cloud service providers may be provisioned in order to perform operations relating to application development.

### BRIEF DESCRIPTION OF THE DRAWINGS

FIG. 1 illustrates an example system consistent with the disclosure.

FIG. 2 is a block diagram of an example computing device for provisioning hybrid cloud resources in an operating environment consistent with the disclosure.

FIG. 3 is a block diagram of an example system consistent with the disclosure.

FIG. 4 illustrates an example method consistent with the disclosure.

### DETAILED DESCRIPTION

Development of applications may be accomplished using an integrated development environment (IDE). For example, an IDE may provide different tools to a user for development of applications, such as source code editors, build automation tools, and/or debuggers, among other tools included in an IDE.

Some applications may be developed as cloud-native applications. For example, an application may be developed as cloud-native to utilize scalable hardware components to deliver application features that integrate across technology boundaries. In other words, the application may not necessarily be tied to discrete computing hardware and as such, can scale up or down based on demand.

However, development of cloud-native applications can pose various challenges. For example, a dedicated cloud environment may have to be deployed each time for each developer of the application. Additionally, new resources from different cloud providers may have to be utilized during development of the particular application. For example, during development of a cloud-native application, a cluster from a first cloud service provider may have to be utilized, while a database from a second cloud service provider may have to be utilized. As used herein, the term “cloud service provider” can, for example, refer to a provider of cloud services. As used herein, the term “cloud services” can, for example, refer to shared pools of attributable computer system resources and services. Users of cloud services may utilize cloud computing resources to perform various computing tasks. Provisioning these hybrid cloud resources can be tedious, inefficient, and subject to error.

Provisioning hybrid cloud resources in an operating environment according to the disclosure can allow for operations relating to an application to be performed utilizing hybrid cloud resources across different cloud service providers. The hybrid cloud resources may be provisioned according to pre-determined operating environment configurations. Accordingly, provisioning hybrid cloud resources in an operating environment according to the disclosure can allow operations relating to an application to be performed while consuming resources from different cloud service providers throughout the development lifecycle of the application.

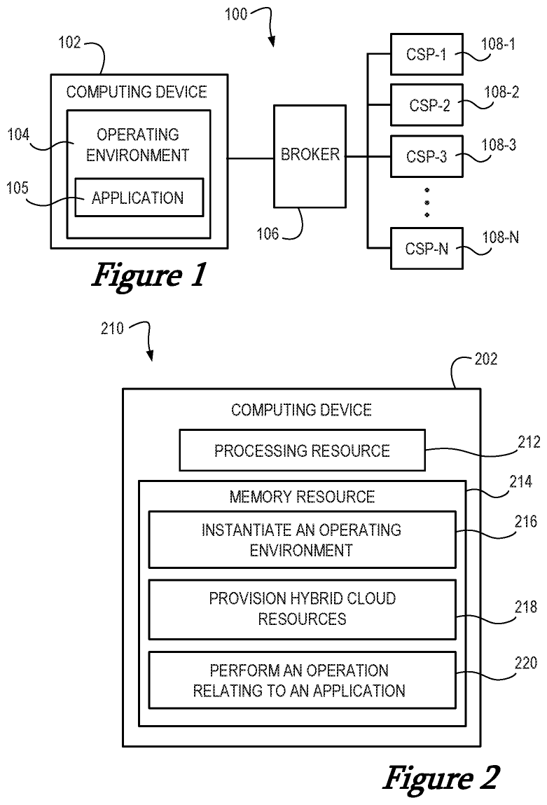

FIG. 1 illustrates an example system 100 consistent with the disclosure. As illustrated in FIG. 1, the system 100 can include computing device 102, broker 106, and cloud service providers 108-1, 108-2, 108-3, 108-N (referred to collectively herein as cloud service providers 108). Computing device 102 can include operating environment 104 and application 105.

System 100 can include computing device 102. As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Computing device 102 can be utilized for provisioning hybrid cloud resources in an operating environment. For example, computing device 102 can be utilized to instantiate an operating environment 104 and provision hybrid cloud resources for the operating environment provided by cloud service providers 108, as is further described herein. As used herein, the term “operating environment” can, for example, refer to an environment having different tools and/or services available for use by a user for development of an application. As used herein, the term “application” can, for example, refer to a set of instructions that are executed by a processor to perform a task. The application 105 can be, for example, a cloud-native application which may not necessarily be tied to discrete computing hardware for execution and as such, can scale up or down based on demand. For example, the application 105 can be a set of non-transitory machine-readable instructions that are executed by a processor provided as a cloud resource to perform a coordinated function, task, and/or activity, as is further described herein.

Developing an application 105, such as a cloud-native application, can be streamlined when using cloud resources from various cloud service providers 108. Accordingly, operating environment 104 can interface with an IDE (e.g., via a plugin) such that developers of application 105 can utilize resources from cloud service provider 108-1 and resources from cloud service provider 108-2, as well as resources from any other cloud service provider 108 in a streamlined way, as is further described herein.

To utilize resources from various cloud service providers 108, computing device 102 can instantiate operating environment 104. As used herein, the term “instantiate” can, for example, refer to creation of an instance of an object in a particular programming language. For example, computing device 102 can create an instance of operating environment 104.

Operating environment 104 can be instantiated according to a pre-determined operating environment configuration. As used herein, the term “operating environment configuration” can, for example, refer to a set of rules dictating an arrangement of services provided by a particular operating environment. For example, operating environment 104 can include rules dictating which cloud service providers 108 computing device 102 can access, an amount of cloud resources available from each cloud service provider 108 computing device 102 can access, etc.

As described above, the operating environment configuration can be pre-determined. That is, a user such as an administrator can create a particular operating environment having the pre-determined operating environment configuration which computing device 102 can instantiate. In other words, the operating environment 104 can be one of many different pre-determined operating environments, where the different pre-determined operating environments may include different operating environment configurations. The different pre-determined operating environments can be created by an administrator and a particular operating environment (e.g., operating environment 104) can be selected according to its operating environment configuration, as is further described herein.

Instantiation of operating environment 104 can include loading input configurations and establishing initial setup with cloud service providers 108. Further, operating environment 104 may be selected based on an application 105 being in a testing environment, deployment environment, etc.

Instantiation of operating environment 104 can include establishing a connection with a list of cloud service providers 108 included in the pre-determined operating environment configuration. For example, operating environment 104 can include an operating environment configuration in which cloud service providers 108-1 and 108-2 are available to provide cloud resources for operating environment 104. Accordingly, computing device 102 can establish a connection with cloud service providers 108-1 and 108-2.

As cloud service providers 108-1, 108-2, 108-3, 108-N can provide cloud resources to operating environment 104, the cloud resources can be referred to as hybrid cloud resources. For example, cloud service provider 108-1 may be Amazon Web Services (AWS), cloud service provider 108-2 may be VMWare, cloud service provider 108-3 may be Azure, etc. In other words, each cloud service provider 108 can provide interconnected services to operating environment 104.

Computing device 102 can provision hybrid cloud resources for operating environment 104 using the pre-determined operating environment configuration. Continuing with the example from above, the pre-determined operating environment configuration can specify cloud service providers 108-1 and 108-2 are available to provide cloud resources for operating environment 104. Accordingly, computing device 102 can provision hybrid cloud resources from cloud service providers 108-1 and 108-2 for operating environment 104. In other words, computing device 102 can provision hybrid cloud resources from cloud service providers 108-1 and 108-2 that are included in the list of cloud service providers 108 specified by the pre-determined operating environment configuration.

As described above, operating environment 104 can interface with an IDE via a plugin. In some examples, computing device 102 can provision hybrid cloud resources via a command prompt (CMD) from the IDE via a plugin. As used herein, the term “command prompt” can, for example, refer to a command line interpreter application to execute entered commands. For instance, the CMD from the IDE may receive a command to provision hybrid cloud resources and, in response, computing device 102 can provision the hybrid cloud resources. In some examples, computing device 102 can provision hybrid cloud resources via an application programming interface (API) from the IDE via a plugin. As used herein, the term “application programming interface” can, for example, refer to a set of subroutine definitions, communication protocols, and/or tools to define methods of communication among various components of an application. For instance, the API from the IDE may receive a command to provision hybrid cloud resources and, in response, computing device 102 can provision the hybrid cloud resources.

As illustrated in FIG. 1, system 100 can include broker 106. As used herein, the term “broker” can, for example, refer to an object which arranges calls between two devices. Broker 106 can be a cloud broker or an open source broker (OSB) pattern, as is further described herein.

In some examples, broker 106 can be a cloud broker. As used herein, the term “cloud broker” can, for example, refer to an entity that manages use, performance, and delivery of cloud services and negotiates relationships between cloud service providers and cloud service consumers. For example, broker 106 can manage relationships between computing device 102/operating environment 104 and cloud service providers 108.

In some examples, broker 106 can be an OSB pattern. As used herein, the term “OSB pattern” can, for example, refer to a source-code-released entity that manages relationships between cloud service consumers and cloud service providers. For example, broker 106 can manage relationships between computing device 102/operating environment 104 and cloud service providers 108.

Computing device 102 can verify a user credential. The user credential can be credentials for accessing cloud service providers 108. User credentials may include a username, password, email address, telephone number, among other types of user credentials.

In response to the user credentials not being verified, computing device 102 can prevent hybrid cloud resources from being provisioned. For example, if a user of computing device 102 is an unauthorized user, access to the hybrid cloud resources provided by cloud service providers 108 specified in the pre-determined operating environment configuration can be prevented.

In response to the user credentials being verified, computing device 102 can provision the hybrid cloud resources. For example, if a user of computing device 102 is an authorized user, access to the hybrid cloud resources provided by cloud service providers 108 specified in the pre-determined operating environment configuration can be granted.

According to the examples described herein, computing device 102 can instantiate an operating environment 104 for an application 105 and provision hybrid cloud resources for operating environment 104 using a pre-determined operating environment configuration. As such, hybrid cloud resources may now be available for use by application 105, as is further described herein.

Computing device 102 can perform an operation for application 105 using provisioned hybrid cloud resources from different cloud service providers 108. For example, computing device 102 can perform computing operations for application 105, as is further described herein.

Computing device 102 can perform an operation for application 105 according to a pre-determined application specification. As used herein, the term “application specification” can, for example, refer to a set of rules dictating a type of services utilized for performing an operation for an application. For example, an application specification can include a resource demand for the operation, a resource characteristic for the operation, and/or a specified cloud service provider 108 for the operation, among other specifications, as is further described herein. In other words, a pre-determined application specification can define high-level logical resource types utilized to perform an operation for application 105.

The pre-determined application specification can be user defined. For example, a user such as a developer/programmer of application 105 may specify certain rules/services to be utilized of the available hybrid cloud resources provided by the cloud service providers 108 that were specified in the pre-determined operating environment configuration. In other words, according to the pre-determined operating environment configuration for operating environment 104, cloud service providers 108-1 and 108-2 may provide hybrid cloud resources for operating environment 104, and the pre-determined application specification can specify certain rules/services to be utilized for application 105 from the hybrid cloud resources provided by cloud service providers 108-1 and 108-2.

Computing device 102 can generate the pre-determined application specification. The pre-determined application specification for application 105 can include a specified resource demand for the operation to be performed relating to application 105. For example, the pre-determined application specification can specify memory, processing speeds, computing environments, among other specified resource demands for performing an operation relating to application 105.

The pre-determined application specification for application 105 can include a specified cloud resource characteristic for the operation. For example, the pre-determined application specification can specify load balancing characteristics, storage locations, and/or domain name characteristics, among other specified cloud resource characteristics for performing an operation relating to application 105.

The pre-determined application specification for application 105 can include specified cloud service provider preferences for each portion of an operation. For example, an operation may have two portions, and the preference can specify cloud service provider 108-1 for a first portion of the operation and cloud service provider 108-2 for a second portion of the operation, among other cloud service provider preferences for performing an operation relating to application 105.

Computing device 102 can perform an operation including creating an application stack relating to application 105 using the provisioned hybrid cloud resources. As used herein, the term “application stack” can, for example, refer to a set of software subsystems to create a platform in which a piece of software is executed. For example, computing device 102 can create an application stack relating to application 105 in which application 105 can be tested, executed, etc.

Computing device 102 can create the application stack using provisioned hybrid cloud resources from a first cloud service provider 108 included in the pre-determined application specification and a second cloud service provider 108 included in the pre-determined application specification. For example, operating environment 104 can include a pre-determined operating environment configuration in which cloud service providers 108-1, 108-2, and 108-3 provide provisioned cloud resources for operating environment 104. The pre-determined application specification can specify cloud service providers 108-1 and 108-2 for a particular operation (e.g., creating an application stack) relating to application 105. Accordingly, computing device 102 can create an application stack for the application 105 utilizing hybrid cloud resources from cloud service providers 108-1 and 108-2. Further, while cloud service provider 103-3 may have cloud resources provisioned for operating environment 104, they may not be utilized for the particular operation, but may be available for other operations in environment 104.

As an example, an application stack for application 105 can be performed by computing device 102. For instance, a web instance may be realized using hybrid cloud resources from a first cloud service provider 108-1 (e.g., AWS:EC2:t2-medium) whereas a database instance can be realized using hybrid cloud resources from a second cloud service provider 108-2 (e.g., OneSphere:Vmware), where the second cloud service provider 108-2 may be a private cloud service provider and the first cloud service provider 108-1 may be a public cloud service provider.

Although an operation is described above as an application stack having hybrid cloud resources (e.g., a web instance) from a first cloud service provider and hybrid cloud resources (e.g., a database instance) from a second cloud service provider, examples of the disclosure are not so limited. For example, the hybrid cloud resources are not limited to a web instance and database instance; cloud services can be any other type of cloud service offered by a cloud service provider. Further, the types of hybrid cloud resources described above are not limited to the above described public/private cloud service provider combination; the types of cloud services may be provisioned from any other combination of cloud service provider.

In some examples, computing device 102 can perform an operation including creating a web instance relating to application 105 using the provisioned hybrid cloud resources. As used herein, the term “web instance” can, for example, refer to a realization of an object. For example, a web instance can include a realization of application 105 on the web. For example, computing device 102 can create a web instance relating to application 105 in which application 105 can be executed, etc.

Computing device 102 can create the web instance using provisioned hybrid cloud resources from a first cloud service provider 108 included in the pre-determined application specification and a second cloud service provider 108 included in the pre-determined application specification. For example, operating environment 104 can include a pre-determined operating environment configuration in which cloud service providers 108-1, 108-2, and 108-3 provide provisioned cloud resources for operating environment 104. The pre-determined application specification can specify cloud service providers 108-1 and 108-2 for a particular operation (e.g., creating a web instance) relating to application 105. Accordingly, computing device 102 can create web instance for the application 105 utilizing hybrid cloud resources from cloud service providers 108-1 and 108-2. Further, while cloud service provider 103-3 may have cloud resources provisioned for operating environment 104, they may not be utilized for the particular operation, but may be available for other operations in environment 104.

As an example, a web instance for application 105 can be performed by computing device 102. For instance, a web instance may be associated with a DNS name and elastic Internet Protocol address (EIP) using hybrid cloud resources from a first cloud service provider 108-1, whereas a database instance can be realized using hybrid cloud resources from a second cloud service provider 108-2.

According to the examples described above, an application stack and web instance can be realized utilizing different hybrid cloud resources. For example, a web instance can be realized using an AWS EC2 instance, which can be associated with a DNS name and an EIP provided by AWS. Further, a database instance can be realized utilizing an on-premise VMWare cluster having associated Floating-IP to provide external connectivity. Further, the web instance can connect to the Floating-IP through the Internet. However, examples of the disclosure are not related to the above operations using the different hybrid cloud resources.

Although operations are described above as including creating an application stack and/or a web instance, examples of the disclosure are not so limited. For example, an operation relating to application 105 can include any other operation utilizing provisioned hybrid cloud resources.

As described above, an operating environment such as operating environment 104 can be created by a user such as an administrator. In some examples, an administrator can create an operating environment via an administrative computing device, although examples of the disclosure are not so limited (e.g., the administrator could create an operating environment using computing device 102).

Creating the operating environment can include discovering a total amount of cloud service providers. For example, a computing device (e.g., computing device 102, administrative computing device, or other computing device) can search for available cloud service providers 108 and create a list of all discovered cloud service providers 108. Credentials of each discovered cloud service provider 108 can be stored in a database (e.g., remote or local) for credential verification, as previously described above.

Creation of an operating environment 104 can include specifying rules dictating which cloud service providers 108 computing device 102 can access, an amount of cloud resources available from each cloud service provider 108 computing device 102 can access, etc. In some examples, the operating environment 104 can be created based on the pre-determined application specification.

For example, creation of an operating environment 104 can include configuring a subset of cloud service providers from the list of all discovered cloud service providers. For example, a sub-set of the total amount of cloud service providers 108 may be specified such that the specified sub-set of cloud service providers are available for the particular operating environment. For instance, for operating environment 104, the sub-set of cloud service providers list may include cloud service providers 108-1 and 108-3, although examples of the disclosure are not so limited.

In some examples, particular cloud resources of cloud service providers 108 can be included in the cloud service provider list. For example, the cloud service provider list may include a web instance from a particular cloud service provider (e.g., 108-1) and a database instance from a different cloud service provider (e.g., 108-2). In other words, cloud resource types may be specified rather than entire cloud service providers 108 in the cloud service provider list.

The created operating environment 104 may be staged. As used herein, the term “stage” can, for example, refer to preparing the operating environment for instantiation. Staging the created operating environment 104 can include compressing the operating environment 104.

Once the operating environment 104 is staged, computing device 102 may select operating environment 104. Computing device 102 may then instantiate operating environment 104, provision hybrid cloud resources for the operating environment 104, and perform operations relating to an application using the provisioned hybrid cloud resources, as previously described above.

Creation of operating environments may be repeated to create other operating environments which may be instantiated. For example, operating environment 104 may include hybrid cloud resources available from cloud service providers 108-1 and 108-3, another operating environment may include hybrid cloud resources available from cloud service providers 108-1 and 108-2, a third operating environment may include hybrid cloud resources available from cloud service providers 108-2 and 108-3, etc.

Provisioning hybrid cloud resources in an operating environment, according to the disclosure, can allow for user specified hybrid cloud resources to be provisioned in a cloud operating environment for performing operations relating to an application using different cloud service providers. Utilizing hybrid cloud resources can allow for application developers to easily integrate specified resources from various cloud service providers during application development. For example, an application can be easily and efficiently developed while consuming integrated hybrid cloud resources from different cloud service providers throughout the development lifecycle of the application. Accordingly, the operating environment can be a specified sandboxed environment according to user specified configurations to easily and efficiently utilize different hybrid cloud resources.

FIG. 2 is a block diagram 210 of an example computing device 202 for provisioning hybrid cloud resources in an operating environment consistent with the disclosure. As described herein, the computing device 202 may perform a number of functions related to provisioning hybrid cloud resources in an operating environment. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and the computing device 202 may be distributed across multiple processors. Put another way, the instructions executed by the computing device 202 may be stored across multiple machine-readable storage mediums and executed across multiple processors, such as in a distributed or virtual computing environment.

As illustrated in FIG. 2, the computing device 202 may comprise a processing resource 212, and a memory resource 214 storing machine-readable instructions to cause the processing resource 212 to perform a number of operations related to provisioning hybrid cloud resources in an operating environment. That is, using the processing resource 212 and the memory resource 214, the computing device 202 may provision hybrid cloud resources in an operating environment, among other operations. Processing resource 212 may be a central processing unit (CPU), microprocessor, and/or other hardware device suitable for retrieval and execution of instructions stored in memory resource 214.

The computing device 202 may include instructions 216 stored in the memory resource 214 and executable by the processing resource 212 to instantiate an operating environment. Computing device 202 can instantiate an operating environment according to a pre-determined operating environment configuration.

The computing device 202 may include instructions 218 stored in the memory resource 214 and executable by the processing resource 212 to provision hybrid cloud resources. Computing device 202 can provision the hybrid cloud resources for the operating environment using the pre-determined operating environment configuration.

The computing device 202 may include instructions 220 stored in the memory resource 214 and executable by the processing resource 212 to perform an operation relating to an application. Computing device 202 can perform an operating relating to an application using the provisioned hybrid cloud resources provided by at least one cloud service provider included in a pre-determined application specification.

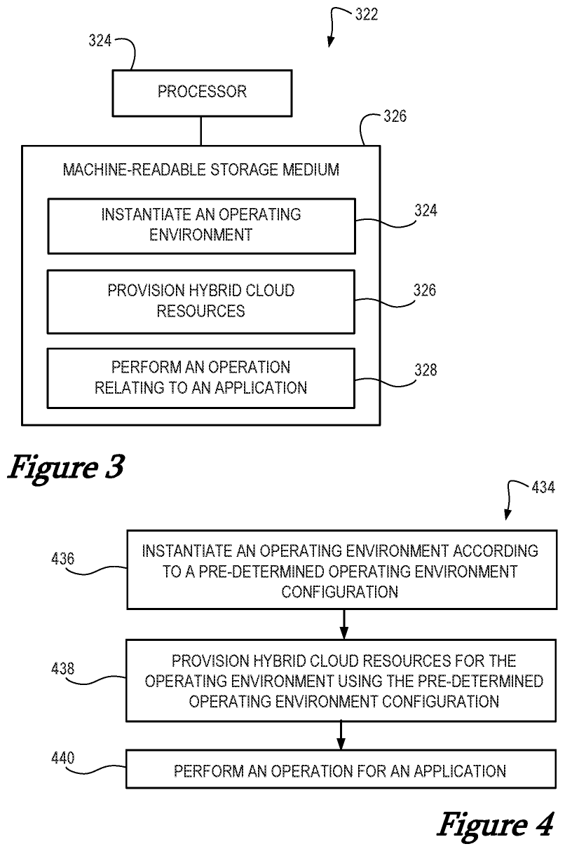

FIG. 3 is a block diagram of an example system 322 consistent with the disclosure. In the example of FIG. 3, system 322 includes a processor 324 and a machine-readable storage medium 326. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 324 may be a central processing unit (CPU), microprocessor, and/or other hardware device suitable for retrieval and execution of instructions stored in machine-readable storage medium 326. In the particular example shown in FIG. 3, processor 324 may receive, determine, and send instructions 328, 330, 332. As an alternative or in addition to retrieving and executing instructions, processor 324 may include an electronic circuit comprising a number of electronic components for performing the operations of the instructions in machine-readable storage medium 326. With respect to the executable instruction representations or boxes described and shown herein, it should be understood that part or all of the executable instructions and/or electronic circuits included within one box may be included in a different box shown in the figures or in a different box not shown.

Machine-readable storage medium 326 may be any electronic, magnetic, optical, or other physical storage device that stores executable instructions. Thus, machine-readable storage medium 326 may be, for example, Random Access Memory (RAM), an Electrically-Erasable Programmable Read-Only Memory (EEPROM), a storage drive, an optical disc, and the like. The executable instructions may be “installed” on the system 322 illustrated in FIG. 3. Machine-readable storage medium 326 may be a portable, external or remote storage medium, for example, that allows the system 322 to download the instructions from the portable/external/remote storage medium. In this situation, the executable instructions may be part of an “installation package”. As described herein, machine-readable storage medium 326 may be encoded with executable instructions for provisioning hybrid cloud resources in an operating environment.

Instantiate instructions 328, when executed by a processor such as processor 324, may cause system 322 to instantiate an operating environment. The operating environment can be instantiated according to a pre-determined operating environment configuration. The pre-determined operating environment configuration can include rules dictating which cloud service providers are accessible, an amount of cloud resources available from each cloud service provider, etc.

Provision instructions 330, when executed by a processor such as processor 324, may cause system 322 to provision hybrid cloud resources for the operating environment using the pre-determined operating environment configuration.

Perform instructions 332, when executed by a processor such as processor 324, may cause system 322 to perform an operation for an application. The operation for the application can be performed using provisioned hybrid cloud resources from different cloud service providers included in a pre-determined application specification. The pre-determined application specification can include a resource demand for the operation, a resource characteristic for the operation, and/or a specified cloud service provider preference for the operation, among other specifications. In other words, a pre-determined application specification can define high-level logical resource types utilized to perform an operation for the application.

FIG. 4 illustrates an example method 434 consistent with the disclosure. Method 434 may be performed, for example, by a computing device (e.g., computing device 102, 202, previously described in connection with FIGS. 1 and 2, respectively).

At 436, the method 434 may include instantiating, by a computing device, an operating environment according to a pre-determined operating environment configuration. The pre-determined operating environment configuration can include rules dictating which cloud service providers are accessible, an amount of cloud resources available from each cloud service provider, etc.

At 438, the method 434 may include provisioning, by the computing device, hybrid cloud resources for the operating environment. The hybrid cloud resources can be provisioned for the operating environment using the pre-determined operating environment configuration.

At 440, the method 434 may include performing, by the computing device, an operation for an application. The computing device may perform the operation for the application using provisioned hybrid cloud resources from a first cloud service provider included in a pre-determined application specification and provisioned hybrid cloud resources from a second cloud service provider included in the pre-determined application specification. The pre-determined application specification can include a resource demand for the operation, a resource characteristic for the operation, and/or a specified cloud service provider preference for the operation, among other specifications. In other words, a pre-determined application specification can define high-level logical resource types utilized to perform an operation for the application

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, “a plurality of” an element and/or feature can refer to more than one of such elements and/or features.

What is claimed:

1. A computing device, comprising:
a processing resource; and
a memory resource storing non-transitory machine-readable instructions to cause the processing resource to:
instantiate an operating environment according to a pre-determined operating environment configuration;
provision hybrid cloud resources for the operating environment using the pre-determined operating environment configuration; and
perform an operation relating to an application using the provisioned hybrid cloud resources provided by at least one cloud service provider included in a pre-determined application specification.

2. The computing device of claim 1, including instructions to cause the processing resource to generate the pre-determined application specification according to at least one of:
a specified resource demand for the operation;
a specified cloud resource characteristic for the operation; and
a specified cloud service provider preference for each portion of the operation.

3. The computing device of claim 1, wherein the instructions to instantiate the operating environment further include instructions to cause the processing resource to establish a connection with a list of cloud service providers included in the pre-determined operating environment configuration.

4. The computing device of claim 3, wherein the instructions to provision hybrid cloud resources further include instructions to cause the processing resource to provision hybrid cloud resources from cloud service providers included in the list of cloud service providers.

5. The computing device of claim 1, wherein the instructions to perform an operation further include instructions to cause the processing resource to create an application stack relating to the application using the provisioned hybrid cloud resources.

6. The computing device of claim 5, wherein the application stack is created using:
provisioned hybrid cloud resources from a first cloud service provider included in the pre-determined application specification; and
provisioned hybrid cloud resources from a second cloud service provider included in the pre-determined application specification.

7. The computing device of claim 1, including instructions to cause the processing resource to provision the hybrid cloud resources using the pre-determined operating environment configuration using a command prompt (CMD) or an application programming interface (API).

8. The computing device of claim 1, including instructions to cause the processing resource to verify a user credential.

9. The computing device of claim 8, including instructions to cause the processing resource to provision the hybrid cloud resources in response to the user credential being verified.

10. The computing device of claim 8, including instructions to cause the processing resource to prevent the hybrid cloud resources from being provisioned in response to the user credential not being verified.

11. A non-transitory computer readable medium storing instructions executable by a processing resource to cause the processing resource to:
instantiate an operating environment according to a pre-determined operating environment configuration;
provision hybrid cloud resources for the operating environment using the pre-determined operating environment configuration; and
perform an operation for an application using provisioned hybrid cloud resources from different cloud service providers included in a pre-determined application specification.

12. The medium of claim 11, wherein the instructions to perform an operation further comprise instructions to create a web instance of the application using:
provisioned hybrid cloud resources from a first cloud service provider included in the pre-determined application specification; and
provisioned hybrid cloud resources from a second cloud service provider included in the pre-determined application specification.

13. The medium of claim 11, comprising instructions to provision the hybrid cloud resources using a cloud broker.

14. The medium of claim 11, comprising instructions to provision the hybrid cloud resources using an open source broker (OSB) pattern.

15. A method, comprising:
instantiating, by a computing device, an operating environment according to a pre-determined operating environment configuration;
provisioning, by a computing device, hybrid cloud resources for the operating environment using the pre-determined operating environment configuration; and
performing, by a computing device, an operation for an application using:
provisioned hybrid cloud resources from a first cloud service provider included in a pre-determined application specification; and
provisioned hybrid cloud resources from a second cloud service provider included in the pre-determined application specification.

16. The method of claim 15, wherein the method includes creating, by an administrative computing device, the operating environment.

17. The method of claim 16, wherein creating the operating environment includes:
discovering, by the administrator computing device, a total amount of cloud service providers; and
specifying, by the administrator computing device, a subset of cloud service providers from the total amount of cloud service providers such that the pre-determined operating environment configuration includes the subset of cloud service providers.

18. The method of claim 17, wherein the method includes staging, by the administrator computing device, the operating environment for instantiation by the computing device.

19. The method of claim 18, wherein the method includes selecting, by the computing device, the staged operating environment from a list of staged operating environments.

20. The method of claim 19, wherein the method includes instantiating, by the computing device, the staged operating environment.
